(19) United States
(12) Patent Application Publication
(10) Pub. No.: US 2025/0384266 A1
(43) Pub. Date: Dec. 18, 2025

(54) AUTOMATED CREATION OF DIGITAL TWINS USING GRAPH-BASED INDUSTRIAL DATA

(71) Applicant: Siemens Aktiengesellschaft, Munich (DE)

(72) Inventor: Md Ridwan Iqbal, Plainsboro, NJ (US)

(73) Assignee: Siemens Aktiengesellschaft, Munich (DE)

(21) Appl. No.: 19/130,311

(22) PCT Filed: Nov. 28, 2022
(86) PCT No.: PCT/US2022/080488

§ 371 Date: May 15, 2025

(51) Int. Cl. G06N 3/08

(52) U.S. Cl. CPC G06N 3/08

(57) ABSTRACT

A computer-implemented method for automatically creating a digital twin of an industrial system having one or more devices includes accessing a triple store that includes an aggregated ontology of graph-based industrial data synchronized with the one or more devices. The triple store is queried for a specified device to extract, from the graph-based industrial data, structural information of the specified device defined by a tree comprising a hierarchy of nodes. For each node, a neural network element is assigned based on a mapping of node types to pre-defined neural network elements. The assigned neural network elements are combined based on the tree topology to create a digital twin neural network. The triple store is then queried to extract, form the graph-based industrial data, real-time process data gathered from the specified device at runtime and use the extracted real-time process data to tune parameters of the digital twin neural network.

### TECHNICAL FIELD

The present disclosure generally relates to industry automation, and in particular, to systems and methods for automatically creating a digital twin of an industrial system using graph-based industrial data.

### BACKGROUND

Increasingly, engineering tools for industry automation may embed a digital twin of a real-world industrial system. Providing simulated data using a digital twin can be an important aspect for automated control and diagnostics. However, creating a digital twin that can accurately replicate an industrial system, such as factory or a complex machine with various structural components, is usually difficult and time consuming. In order to create the digital twin, a functional representation must be created that can represent the internal structure of the real-world industrial system. This representation can be in the form a machine learning (ML) model, such as neural network, a Bayesian network, and so on.

As per current practices, the architecture of a ML model describing the functional representation of a digital twin is typically designed manually (hand coded), usually by experienced personnel, and then trained using real-world data. State-of-the-art literature exist that describe such a manually designed architecture informed by expert design. However, such designs can be highly dependent on experienced experts who have had the rare opportunity to work in multiple such design projects and see first-hand what works and what does not. The process can be time-consuming, costly and may not be feasible to be implemented for rapid development.

### SUMMARY

Briefly, aspects of the present disclosure provide a computer-implemented system and method that can utilize graph-based industrial data for automatically mapping a machine learning model architecture of a digital twin and tuning such a digital twin to replicate a real-world industrial system. The graph-based industrial data comprises structural information of individual devices of the industrial system that can be extracted to map a digital twin neural network for a specified device. The graph-based industrial data also integrates real time process data gathered from the individual devices at runtime that can be extracted to tune the digital twin neural network for the specified device.

According to a first aspect of the disclosure, a computer-implemented method is provided for automatically creating a digital twin of an industrial system including one or more devices. The method comprises querying a triple store, which includes an aggregated ontology of graph-based industrial data synchronized with the one or more devices, to extract, for a specified device, structural information of the specified device defined by a tree comprising a hierarchy of nodes. The method further comprises traversing the tree to identify node types of individual nodes and assigning a respective neural network element to each individual node based on a mapping of node types to pre-defined neural network elements. The method further comprises combining the respective neural network elements based on a topology of the tree to create a digital twin neural network. The method further comprises training the digital twin neural network by querying the triple store to extract, from the graph-based industrial data, real-time process data gathered from the specified device at runtime, and using the real-time process data to tune learnable parameters of the digital twin neural network.

Further aspects of the disclosure are directed to computing systems and computer program products including instructions executable by a processor to carry out the above-described method and its optional embodiments.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 shows a simplified system architecture for implementing a method for automatically creating a digital twin of an industrial system using graph-based industrial data according to an example embodiment.

FIG. 2 is a schematic diagram illustrating mapping of a digital twin neural network from structural information extracted from graph-based industrial data.

FIG. 3 shows an example of a computing system that can support automatic creation of a digital twin of an industrial system using graph-based industrial data according to disclosed embodiments.

### DETAILED DESCRIPTION

Industrial automation system components are usually interconnected by specialized networks using standard industrial protocols for access and data exchange. The development of present and future automation systems has put considerable focus on exchanging semantically enriched information aiming for a realization of flexible manufacturing scenarios. Open Platform Communications Unified Architecture (OPC UA) is an industrial standard protocol of the OPC Foundation for manufacturer-independent communication with the purpose of interchanging industrial data, in particular for automation purposes. In the area of factory automation, OPC UA is one of the most promising standards for device communication that can lift low-level signal exchange schemes onto a semantic level, contributing to the realization of flexible manufacturing scenarios. An information model of OPC UA features a semantically enriched and graph-based data structure which is dedicated to automation purposes.

Embodiments of the disclosure utilize graph-based industrial data, such as that obtained from an OPC UA information model, for modeling and tuning a machine learning-based digital twin of an industrial system. The underlying idea of the disclosed embodiments leverages the fact that the graph-based industrial data, particularly that obtained from an OPC UA information model, can integrate structural information and real-time process data (“live data”), thus providing a viable ontology that can be semantically mapped to a machine learning model architecture. The cost and time for developing digital twins can thus be greatly reduced by taking advantage of existing semantic data from factories and machines.

The disclosed embodiments include a digital twin mapping module that can extract structural information of a specified device from the graph-based industrial data and automatically map it to a neural network representation of the device (“digital twin neural network”). The structural information may define the overall structure of the individual devices or machines in a factory by expressing a hierarchy of various components of a device and how one component takes another component as an input. Thus, the structural information may define dependency relationships between components of a device. The disclosed digital twin mapping module can reduce cost by significantly reducing expert involvement and further increase reliability of the digital twin by using actual device structural information.

The disclosed embodiments further include a digital twin training module that can tune the auto-generated digital twin neural network by extracting live data gathered from the specified device and integrated into the graph-based industrial data at runtime. The disclosed digital twin training module can automate and simplify data acquisition and further reduce expert involvement.

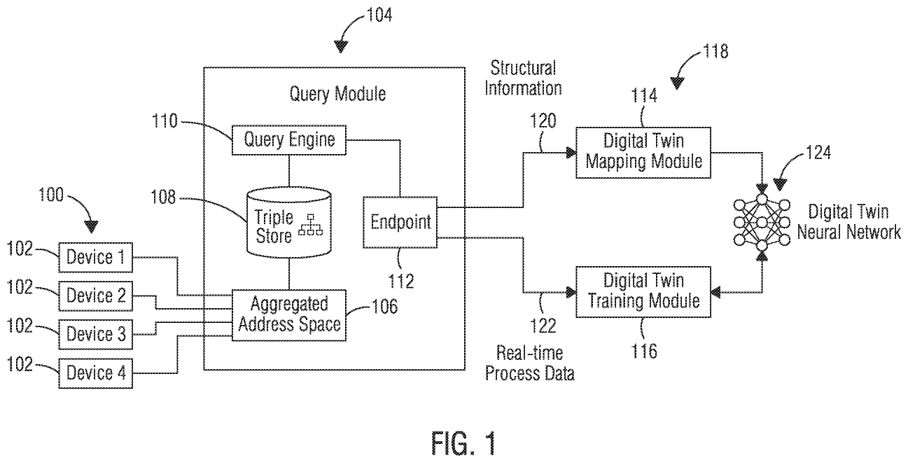

Turning now to the drawings, FIG. 1 illustrates a system architecture for implementing a method for automatically creating a digital twin of an industrial system 100 using graph-based industrial data according to an example embodiment. The various modules described herein, including the query module 104, the digital twin mapping module 114 and the digital twin training module 116, including components thereof, may be implemented in a computing environment in various ways, for example, as hardware and programming. The programming for the modules 104, 114, 116 may take the form of processor-executable instructions stored on non-transitory machine-readable storage mediums and the hardware for the modules may include processors to execute those instructions. The processing capability of the systems, devices, and modules described herein, including the query module, the digital twin mapping module 114 and the digital twin training module 116 may be distributed among multiple system components, such as among multiple processors and memories, optionally including multiple distributed processing systems or cloud/network elements.

Referring to FIG. 1, the industrial system 100 may include at least one, typically a plurality of devices 102. The devices 102 can include, for example, machines on a factory floor, such as robots, CNC machines, etc. The devices 102 may be connected to an industrial network. The query module 104 may be located within, or hierarchically assigned to, an aggregating layer of the industrial network, for example, implemented by an edge or could application or integrated within edge or cloud controller. As shown, the query module 104 may include an aggregated address space 106 communicatively connected to the devices 102, a triple store 108 comprising an aggregated ontology of graph-based industrial data synchronized with the devices 102 obtained via the aggregated address space 106, a query engine 110 for querying the triple store 108 and one or more endpoints 112 that can act as logical query interfaces assigned to interact with client systems. The digital twin mapping module 114 and the digital twin training module 116 may be located in a client system 118 that can exchange query messages with the query module 104 in a query language supported by the assigned endpoint 112. The digital twin mapping module 114 and the digital twin training module 116 may extract structural information 120 and real-time process data 122 respectively by querying the triple store 108 using the query engine 110, to automatically create and tune a digital twin neural network 124 as disclosed herein.

Industrial entities, such as devices 102, are typically equipped with ample resources of storage, communication, and computation. According to disclosed embodiments, each device 102 may include a respective OPC UA server operating therein. Thus, when a device 102 is connected to the industrial network, it can expose its structural information and live data via the respective UPC UA server. The OPC UA servers of the individual devices 102 may be communicatively connected to the aggregated address space 106. The aggregated address space 106 may be synchronized with the devices 102, for example, via an aggregator server (not shown). The aggregated address space 106 can offer access to the OPC UA information model of each device 102 including structural information and live data accrued in and delivered by the respective device 102.

In the OPC UA information model, every entity in the address space is a node. A node is the basic unit of data in the OPC UA address space, which provides a standard way for OPC UA servers to represent objects to OPC UA clients. The OPC UA information model may provide a layered structure as follows:

On a first or lowermost layer, referred to as meta layer, basic entities, e.g., node classes, attributes, references, etc. may be defined.

A second layer, referred to as OPC UA base layer, may be provided by the OPC Foundation itself. This layer may include specifications of base VariableTypes, server types, engineering units etc.

In a third layer, at least one OPC UA companion specification may be used to define domain specific models or schemas extending the OPC UA model. Companion specifications are typically developed by domain experts, standardization bodies or industrial machine suppliers.

A fourth layer, referred to as extension layer, may host original equipment manufacturer (OEM) specific schema extensions authored by OEMs, including, for example, a Device Vendor Information (DVI) model comprising device type descriptions, a Machine Vendor Information (MVI) Model comprising machine type descriptions and a Machine User Information (MUI) model comprising process types or factory element types.

Finally, a fifth layer, referred to as instance layer, located on the top of the layered information model, may include a Device Information Model DIM, i.e., an instance model for describing structure and data items (including live data) of individual devices based on schemas defined in the layers.

The triple store 108 includes a graph database that can store data as statements in the subject-predicate-object format (triple). The aggregated ontology of graph-based industrial data in the triple store 108 may be derived based on the OPC UA information model provided by the aggregated address space 106. For facilitating query within the semantically enriched OPC UA information model, the OPC UA information model may be transformed into a suitable target ontology. According to disclosed embodiments, the aggregated ontology of industrial data in the triple store 108 may include a resource description format (RDF) graph obtained by mapping the OPC UA information model provided by the aggregated address space 106 into a target ontology representation (within each layer) expressed by a web ontology language, such as OWL. Details of this mapping have been described in the publication WO 2020104019 A1, based on an international patent application filed by the present applicant, the content of which is incorporated herein by reference in its entirety.

The ontology included in the triple store 108 may comprise a static portion and a dynamic portion. The static portion may define hierarchy information of nodes (e.g., type-hierarchy), which may result from the transformation of the OPC UA information model provided by the aggregated address space 106 into the RDF representation (i.e., transformed into triples) as a result of an OWL mapping. The hierarchy information defined in the static portion may thus include structural information of individual devices 102. The static portion may be amended if the underlying OPC UA graph structure is updated, which may be triggered, for example, by new devices added to the industrial network. The dynamic portion may be used to provide actual values (e.g., in OPC UA the value-attribute of a variable node like temperature), which can be directly accessed on demand via the aggregated address space 106. In other words, the dynamic portion may include dynamic assignments of data values (i.e., live data) gathered from the individual devices 102 at runtime in response to a query and integrated into the aggregated ontology within the triple store 108 on occurrence of such a query.

To obviate high complexity imposed for querying the semantic descriptions scattered within the aggregated ontology included in the triple store 108, a suitable query language, such as SPARQL, may be used to query the triple store 108. SPARQL is a recursive acronym for SPARQL Protocol and RDF Query Language. According to disclosed embodiments, the query engine 110 may be configured to execute SPARQL query requests delivered by the endpoint 112 against the triple store 108. In an example embodiment, the query engine 110 may be implemented with Apache Jena, an open-source semantic web framework for Java along with Fuseki, a SPARQL query engine with an additional web interface supporting SPARQL for querying. The endpoint 112 may be configured to exchange query messages with the client system 118 in the query language SPARQL or to transform query messages formulated by the client system 118 in a different query language to SPARQL. A detailed description of querying OPC UA information models using SPARQL is available in the publication WO 2020200404 A1, based on an international patent application filed by the present applicant, the content of which is incorporated herein by reference in its entirety.

To create a digital twin of a device 102 connected to the industrial network, the digital twin mapping module 114 may present a query to the triple store 108, for example, via a SPARQL interface as described above, to extract structural information 120 of the specified device 102. The structural information 120 may be defined by a tree comprising a hierarchy of nodes. To illustrate, the structure of a robot may be defined by a hierarchy of nodes, where robot itself defines a root node, and its components are expressed as a hierarchy—e.g., arm of the robot, powertrain of an arm, motor of a powertrain, sensors associated with a motor, etc.—such that each component is identified as a node in the hierarchy.

The nodes may include ObjectTypes, ConfigurationTypes and VariableTypes. The node types may be defined in the companion specification of the OPC UA information model and mapped to OWL classes in the RDF graph. The actual hierarchical structure and data values for a specified device may be defined in the instance layer. The query by the digital twin mapping module 114 may occur at the instance layer. An instance tree of a specified device may be retrieved, for example, by locating a root node in the instance layer using the device name/identifier specified in the query, and then successively determining the child nodes hierarchically related to the root node.

The digital twin mapping module 114 may traverse the retrieved instance tree to identify node types of individual nodes. The nodes of the instance tree may include one or more types of component nodes representing components of the specified device (e.g., robot arm, powertrain, motor, software object etc.), one or more types of sensor nodes comprising sensor data associated with the specified device (e.g., motor temperature sensor) and or more types of configuration nodes comprising configuration data of the specified device (e.g., speed of a robot arm). The type-information of each node may be determined by traversing the instance tree in a direction from the leaf nodes to the root node. In general, the sensor nodes may occur as leaf nodes and the component nodes may occur as intermediate nodes of the instance tree. Configuration nodes refer to nodes that configure the behavior of a tree topology element. Configuration nodes can usually occur as leaf nodes but may, in principle, also occur as intermediate nodes. For example, in case of a OPC UA RDF graph, as the instance tree is traversed, sensor nodes may be identified as nodes represented by VariableTypes that can be filled by value attributes (e.g., AnalogTypes), component nodes may be identified as nodes represented by ObjectTypes, and configuration nodes may be identified as nodes represented by ConfigurationTypes.

Having identified the node type, the digital twin mapping module 114 may assign a respective neural network element to each individual node based on a mapping of node types to pre-defined neural network elements. The mapping may include, for each node type described in the companion specification, a corresponding neural network structure element stored. The neural network element for a given node type may include, for example, a layer of neuronal nodes, or may even include a small neural network. The architecture of a neural network element (e.g., number of layers of neuronal nodes, number of neuronal nodes per layer, connection between nodes, etc.) for each node type in the companion specification may be determined heuristically, for example, based on experimentation by domain experts, and stored in the mapping. Once a mapping is created, it can be used as a look-up by the digital twin mapping module 114 to assign neural network elements to nodes of any queried OPC UA device.

Next, the digital twin mapping module 114 may combine the respective neural network elements assigned to the individual nodes of the instance tree, using the topology of the instance tree, to create a digital twin neural network 124. As described above, the instance tree can define the overall structure of the specified device by expressing a hierarchy of various components of the device and how one component takes another component as an input. Since the instance tree can define dependency relationships between components of the specified device, the topology of the instance tree can be leveraged to combine the neural network elements corresponding to each node of the instance tree to create the digital twin neural network 124. For example, according to a disclosed embodiment: neural network elements corresponding to sensor nodes may form an output layer of the digital twin neural network 124; neural network elements corresponding to configuration nodes may form an input layer of the digital twin neural network 124; and neural network elements corresponding to component nodes may form one or more hidden layers of the digital twin neural network 124. To suitably process dynamically evolving live data, the digital twin neural network 124 may include a recurrent neural network (RNN) architecture.

The disclosed digital twin mapping module 114 can thus use the breadth of information available from semantically enriched graph-based industrial data, such as an OPC UA RDF graph, to intelligently create a digital twin neural network for a specified device, which can be trained easily and can provide accurate results. In the past, for every new device, a digital twin neural network had to be created manually (hand coded) from scratch. According to the disclosed embodiments, the mapping may be coded once, to establish a one-to-one correspondence between node types and neural network elements. Once the mapping is established, the digital twin mapping module 114 can use the mapping to automatically create a digital twin neural network for any specified device, as described above, without further manual effort.

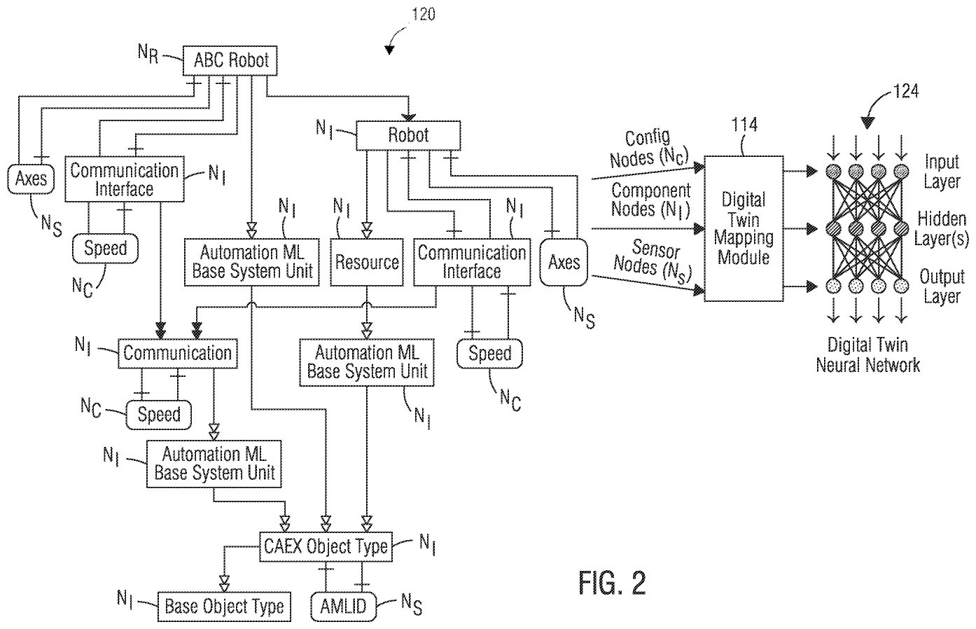

FIG. 2 illustrates an example of how a digital twin mapping module 114 may be used to create a digital twin neural network 124 from an instance tree 120 extracted from an RDF graph. As described above, instance tree 120 can be retrieved by locating a root node NR in the instance layer of the RDF graph using the device name identifier (e.g., ABCRobot) specified in a query, and successively determining the child nodes hierarchically related to the root node NR. The tree 120 is then traversed in a leaf-to-root direction to identify the node types of the nodes. In the shown example, the nodes Nc denote configuration nodes, the nodes Ns denote sensor nodes and the nodes NI denote component nodes. For each node, a pre-defined neural network element is assigned based on its node type using a stored mapping as described above. The assigned neural network elements are then combined using the topology of the instance tree 120 to create the digital twin neural network 124, such that the configuration nodes Nc form an input layer of the digital twin neural network 124, the sensor nodes N_{S} form an output layer of the digital twin neural network 124, and the component nodes N_{I} form intermediate or hidden layers of the digital twin neural network 124. The shown depiction is simplified. For example, in some embodiments, the number of hidden layers of the digital twin neural network 124 may correspond to the number of hierarchical levels of component nodes N_{I} in the instance tree 120.

Continuing with reference to FIG. 1, the digital twin training module 116 may tune the auto-generated digital twin neural network 124 using live data from the specified device 102 in an automated manner. During the training process, the digital twin training module 116 may query the triple store 108, for example via a SPARQL interface as described above, to extract from the graph-based industrial data, real-time process data 122 (live data) gathered from the specified device 102 at runtime. According to the disclosed embodiments, the OPC UA server of each device 102 may communicate data values of such real-time process data during operation of the device 102. The data values for the specified device 102 may be dynamically integrated into the aggregated ontology of graph-based industrial at runtime via the aggregated address space 106 in response to a query presented by the digital twin raining module 116, whereby the training process can be completely or substantially automated.

The extracted real-time process data 122 may include configuration data and sensor data. The real-time process data may be stored as time series data in the graph-based industrial data. The training process may involve tuning the learnable parameters (e.g., weights, biases) of the digital twin neural network 124, which may include an RNN, using the extracted real-time process data 122. According to the disclosed embodiments, the digital twin training module 116 may use the configuration data to define an input to the digital twin neural network 124 and use the sensor data as ground truth. The training process may comprise iteratively using the learnable parameters of the digital twin neural network 124 to generate an output based on the input configuration data, and adjusting the learnable parameters to reduce an error between the output and the ground truth defined by the sensor data. The steps may be executed continuously over a number of epochs until a convergence criterion is met. The convergence criterion may be met, for example, after a pre-defined number of epochs, or when the error function is minimized, among others.

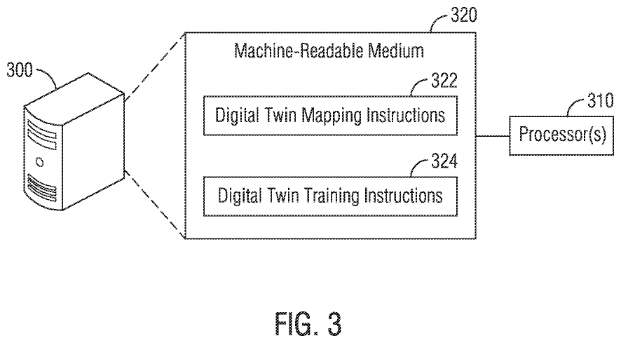

FIG. 3 shows an example of a computing system 300 that can support automatic creation of a digital twin of an industrial system using graph-based industrial data according to disclosed embodiments. The computing system 300 includes at least one processor 310, which may take the form of a single or multiple processors. The processor(s) 310 may include a central processing unit (CPU), a graphics processing unit (GPU), a neural processing unit (NPU), a microprocessor, or any hardware device suitable for executing instructions stored on a memory comprising a machine-readable medium. The computing system 300 further includes a machine-readable medium 320. The machine-readable medium 320 may take the form of any non-transitory electronic, magnetic, optical, or other physical storage device that stores executable instructions, such as digital twin mapping instructions 322 and digital twin training instructions 324, as shown in FIG. 3. As such, the machine-readable medium 320 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 300 may execute instructions stored on the machine-readable medium 320 through the processor(s) 310. Executing the instructions (e.g., the digital twin mapping instructions 322 and the digital twin training instructions 324) may cause the computing system 300 to perform any of the technical features described herein, including according to any of the features of the digital twin mapping module 114 and the digital twin training module 116 described above.

The systems, methods, devices, and logic described above, including the digital twin mapping module 114 and the digital twin training module 116, may be implemented in many different ways in many different combinations of hardware, logic, circuitry, and executable instructions stored on a machine-readable medium. For example, these modules may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the digital twin mapping module 114 and the digital twin training module 116. Computer readable program instructions described herein can be downloaded to respective computing/processing devices from a computer readable storage medium or to an external computer or external storage device via a network, for example, the Internet, a local area network, a wide area network and/or a wireless network.

The processing capability of the systems, devices, and modules described herein, including the digital twin mapping module 114 and the digital twin training module 116, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

Although this disclosure has been described with reference to particular embodiments, it is to be understood that the embodiments and variations shown and described herein are for illustration purposes only. Modifications to the current design may be implemented by those skilled in the art, without departing from the scope of the patent claims.

1. A computer-implemented method for automatically creating a digital twin of an industrial system including one or more devices, the method comprising:
querying a triple store, which includes an aggregated ontology of graph-based industrial data synchronized with the one or more devices, to extract, for a specified device, structural information of the specified device defined by a tree comprising a hierarchy of nodes,
traversing the tree to identify node types of individual nodes and assigning a respective neural network element to each individual node based on a mapping of node types to pre-defined neural network elements,
combining the respective neural network elements based on a topology of the tree to create a digital twin neural network, and
training the digital twin neural network by querying the triple store to extract, from the graph-based industrial data, real-time process data gathered from the specified device at runtime, and using the real-time process data to tune learnable parameters of the digital twin neural network.

2. The method according to claim 1, wherein the nodes of the tree defining the structural information include nodes include one or more types of component nodes that represent components of the specified device, one or more types of sensor nodes that comprise sensor data associated with the specified device and one or more types of configuration nodes that comprise configuration data of the specified device.

3. The method according to claim 2, wherein the respective neural network elements assigned to the individual nodes are combined based on the topology of the tree such that:
neural network elements corresponding to the one or more types of sensor nodes form an output layer of the digital twin neural network,
neural network elements corresponding to the one or more types of configuration nodes form an input layer of the digital twin neural network, and
neural network elements corresponding to the one or more types of component nodes form one or more hidden layers of the digital twin neural network.

4. The method according to claim 3, wherein the real-time process data extracted from the graph-based industrial data include configuration data and sensor data.

5. The method according to claim 4, wherein the learnable parameters of the digital twin neural network are tuned by performing, over a number of iterations:
using the configuration data to define an input to the digital twin neural network,
using the learnable parameters of the digital twin neural network to generate an output, and
adjusting the learnable parameters to reduce an error between the output and a ground truth defined by the sensor data.

6. The method according to claim 1, wherein the real-time process data is stored as time series data in the graph-based industrial data.

7. The method according to claim 6, wherein the digital twin neural network comprises a recurrent neural network.

8. The method according to claim 1, wherein each of the one or more devices includes a respective Open Platform Communications Unified Architecture (OPC UA) server communicatively connected to an aggregated address space, wherein the aggregated ontology of graph-based industrial data is derived based on an OPC UA information model provided by the aggregated address space.

9. The method according to claim 8, wherein the aggregated ontology of graph-based industrial data comprises a resource description format (RDF) graph obtained by transforming the OPC UA information model provided by the aggregated address space into a target ontology.

10. The method according to claim 9, wherein the RDF graph is queried via a SPARQL interface.

11. A non-transitory computer-readable storage medium including instructions that, when processed by computing system, configure the computing system to perform the method according to claim 1.

12. A computing system for automatically creating a digital twin of an industrial system including one or more devices, comprising:
one or more processors,
a non-transitory memory in communication with the one or more processors, the non-transitory memory including algorithmic modules executable by the one or more processors, the algorithmic modules comprising:
a digital twin mapping module configured to:
query a triple store, which includes an aggregated ontology of graph-based industrial data synchronized with the one or more devices, to extract, for a specified device, structural information of the specified device defined by a tree comprising a hierarchy of nodes,
traverse the tree to identify node types of individual nodes and assign a respective neural network element to each individual node based on a mapping of node types to pre-defined neural network elements, and
combining the respective neural network elements based on a topology of the tree to create a digital twin neural network, and a digital twin training module configured to:
query the triple store to extract, from the graph-based industrial data, real-time process data gathered from the specified device at runtime, and
use the real-time process data to tune learnable parameters of the digital twin neural network.

13. The computing system according to claim 12, wherein the nodes of the tree defining the structural information include nodes include one or more types of component nodes that represent components of the specified device, one or more types of sensor nodes that comprise sensor data associated with the specified device and one or more types of configuration nodes that comprise configuration data of the specified device.

14. The computing system according to claim 13, wherein the digital twin mapping module is configured to combine the respective neural network elements assigned to the individual nodes based on the topology of the tree such that:
neural network elements corresponding to the one or more types of sensor nodes form an output layer of the digital twin neural network,
neural network elements corresponding to the one or more types of configuration nodes form an input layer of the digital twin neural network, and
neural network elements corresponding to the one or more types of component nodes form one or more hidden layers of the digital twin neural network.

15. The computing system according to claim 14, wherein the digital twin training module is configured such that the real-time process data extracted from the graph-based industrial data include configuration data and sensor data.

16. The computing system according to claim 14, wherein the digital twin training module is configured to tune the learnable parameters of the digital twin neural network by performing, over a number of iterations:
use the configuration data to define an input to the digital twin neural network,
use the learnable parameters of the digital twin neural network to generate an output, and
adjust the learnable parameters to reduce an error between the output and a ground truth defined by the sensor data.

17. The computing system according to claim 12, wherein the real-time process data is stored as time series data in the graph-based industrial data.

18. The computing system according to claim 17, wherein the digital twin neural network comprises a recurrent neural network.

19. The computing system according to claim 12, wherein each of the one or more devices includes a respective Open Platform Communications Unified Architecture (OPC UA) server communicatively connected to an aggregated address space, wherein the aggregated ontology of graph-based industrial data is derived based on an OPC UA information model provided by the aggregated address space.

20. The computing system according to claim 19, wherein the aggregated ontology of graph-based industrial data comprises a resource description format (RDF) graph obtained by transforming the OPC UA information model provided by the aggregated address space into a target ontology.
